(19) United States
(12) Patent Application Publication
(10) Pub. No.: US 2005/0111709 A1
(43) Pub. Date: May 26, 2005

(54) Identification system

(76) Inventor: Catherine Topping, Worcester (GB)

Correspondence Address: JOEL D. SKINNER, JR.;SKINNER AND ASSOCIATES, 212 COMMERCIAL ST., HUDSON, WI, 54016, US

(21) Appl. No.: 10/955,842

(22) Filed: Sep. 30, 2004

Related U.S. Application Data
(63) Continuation-in-part of application No. 10/720,741, filed on Nov. 24, 2003.
Application No. 10/720,741 is a continuation-in-part of application No. 09/558,828, filed on Apr. 26, 2000, now Pat. No. 6,654,484.

(30) Foreign Application Priority Data
Oct. 28, 1999 (GB) GB9925587.9
Dec. 19, 1999 (GB) GB9927757.4

(51) Int. Cl. G06K 9/00

(52) U.S. Cl. 382/124

(57) ABSTRACT

An identification system for use in controlling the operation of a device comprises comparing fingerprint data with stored data to identify both an individual and which of the individual's fingerprints has been input, and using the identity of the individual and the finger in controlling the operation of the device.

This application is a Continuation-in-Part of U.S. patent application Ser. No. 10/720,741 filed 24^{th} Nov. 2003 which is a Continuation-in-Part of U.S. patent application Ser. No. 09/558,828 filed 26^{th} Apr. 2000.

The invention relates to an identification system for use in identifying an individual.

It is well known to use fingerprint pattern recognition in the identification of people. For example fingerprint pattern records have been used by the police around the world to identify individuals. It is also known to use electronic fingerprint pattern recognition systems to control access rights in computer systems, the computer holding a database of fingerprint patterns of authorised users and only permitting use of the computer or certain operations of the computer by individuals whose fingerprint pattern match one of the fingerprint patterns stored in the database. Typically, only one fingerprint pattern is used in the matching process.

Although fingerprints are widely recognised as being a good identification tool, there are a number of other biometric characteristics, which can be used to identify an individual, for example hand geometry, iris, retina, facial, voice or DNA pattern recognition techniques are known. New biometric recognition techniques are under development and have the potential to act as identification tools.

In order to achieve an increased level of security, it is known, for example from U.S. Pat. No. 6,393,139, to require a user of a computer system to enter a User ID and two or more fingerprint or biometric patterns, in a predetermined order or sequence, before granting access to the computer. U.S. Pat. No. 6,393,139 uses a recognition table to store both the User ID and the biometric sequence data and requires the User ID to initially identify the user and the biometric sequence data to then confirm the identity of the individual selected by the User ID.

Global individual identity management requires a biometric identification system which can uniquely identify an individual from their biometric characteristics alone. For example an illegal immigrant is unlikely to have a User ID or Personal Reference number and has to be identified solely from their biometric characteristics, so the technique described in U.S. Pat. No. 6,393,139 is unsuitable for use in such applications. In addition the identification method of U.S. Pat. No. 6,393,139 will be cumbersome and slow to identify one individual from a large number of individuals listed on a recognition table. For Global identity management and large scale biometric systems it will be necessary to use existing or future high performance biometric database systems rather than a proprietary recognition table.

There is widespread concern about the ability of hackers to copy a biometric characteristic, for example to lift a fingerprint from an object and create a dummy fingerprint and thereby gain unauthorised access to an individual's bank account or credit card account and to conduct illegal transactions via the internet, or at a financial terminal like an ATM or a Point of Sale terminal.

Identity theft is also an increasing concern to governments and organisations where illegal use of another person's identity for criminal or illegal access purposes is a concern.

Another concern has been the privacy of the individual's biometric data as an individual's biometric characteristic cannot be changed, whereas a password or PIN number can be changed. For example, where a government issues a Citizen ID Card containing the citizen's biometric data and this biometric data is also being used for identification for e-commerce, transaction processing, computer access control and access to secure sites like homes, offices and airports, an individual's biometric information may be stored in a range of locations, thus the risk of unauthorised access to the data being gained is fairly high. The concern is that as a biometric characteristic is unchangeable, once it is hacked or unauthorised access to it is gained, it can be used to gain unauthorised access to the citizen's bank account, computer or secure site or to claim financial benefits from the Government. Freedom of Rights issues are also clearly involved in the above scenario.

The present invention is intended to provide an identification system having an improved level of security over a single finger or other single entry biometric identification systems and to provide an identification system capable of identifying individuals solely from their biometric characteristics. The invention enables an individual to choose to enable one function out of a plurality of functions by use of different biometric characteristics or by use of a sequence of entries within a biometric characteristic or a sequence of entries of different biometric characteristics.

For simplicity, in the description and examples that follow, the fingerprint is mainly used to illustrate a suitable biometric characteristic. However other biometric characteristics, for example, hand geometry, iris, retina, facial, voice or DNA, or combinations thereof, can be used as appropriate and are considered within the spirit of the invention.

Where references to the input of several biometric characteristics are included, these could, by way of example, be to the entering of data relating to several fingerprint patterns, and/or to the entry of data relating to other characteristics or multi-modal combinations of characteristics.

According to the invention there is provided a secure control system for use in controlling the operation of a device having a plurality of functions. The secure control system comprises inputting biometric data relating to a biometric characteristic of an individual, for example fingerprint pattern data relating to a fingerprint pattern of an individual is input using a fingerprint pattern reader, comparing the biometric data with stored biometric data to identify the individual whose biometric data has been input and to identify to which of the individual's biometric characteristics the biometric data relates, and by referencing the identified characteristic to one of a plurality of functions, controlling the operation of the device in response to the data representative of the identity of both of the individual and of the biometric characteristic to perform a selected one of the plurality of functions.

For example, where fingerprint pattern data is used, the identity of both the individual and of the finger used to input the data is used to select which of the functions of the device is to be performed.

The invention also provides additional flexibility by allowing the individual to choose to use more than one finger to perform more than one function at the same time. For example on a computer system, Finger 1 may open access to the Patient Record system and Finger 2 may open access to the Prescription Application in the Patient Record system. In this case, entering Finger 1 followed by Finger 2 can identify the individual and authorise access to both the Patient Record system and the Prescription Application in one step.

Another possible use for the invention is in logging on to a computer system with a range of access rights. As the system identifies both the user and which finger is being used, the system may be set up so that the use of one finger gives the individual a restricted level of access, the use of a different finger gives additional access rights, and the use of a third finger gives further access rights. Again, as the identity of the user is checked, access to certain areas can be restricted to smaller groups of authorised users. In all cases both the identity of the user and the choice of access levels can be audited for reference and control purposes.

In a further possible application, the input fingerprint data could be transmitted to a remote location where the identification process is performed and a device controlled in response to the fingerprint data being recognised. The fingerprint data would then be acting, in effect, as remote access control system.

Clearly, if the device at the remote location requires several fingerprints to be entered in a particular sequence, then the system is of a good level of security.

The invention allows the security to be further enhanced by requiring two or more fingerprints or fingerprint sequences to be used to identify an individual and permit the operation of a device. One fingerprint or fingerprint sequence would identify the individual and the second and fingerprint or fingerprint sequences would confirm identity of the individual and permit the operation of the device. The individual could be requested to enter the second fingerprint or fingerprint sequence whenever a more positive identification of the individual is required before operation of a device. In this way the system provides an advanced access control or secure remote control or dial-in security system.

The system could also be used with other devices incorporating switches, the use of the switch depending upon fingerprint identification of the individual and the function operated being dependent on which of the individual's fingers or fingerprint sequence is being used.

The system could alternatively be used in an access system having a duress warning system. In normal use, one of the user's fingers or finger sequence is used to gain access, for example to a computer system, the use of another of the user's fingers or finger sequences also gaining access, possibly at a restricted level, and also triggering an alarm or warning that the user has been forced to use the system under duress.

Another use for the system is where devices must be operated, either in areas of poor light or by the visually impaired. In such cases, the use of a traditional key pad or control panel having buttons may be impractical, and instead the device may be operated by sensing which of an individual's fingers has been placed on a fingerprint reader, and associating a function with each finger.

In all the above examples, if the device requires several fingerprints to be entered in a particular sequence, then the system is of a good level of security.

Alternatively a number may be associated with each finger thereby permitting numbers to be entered instead of using a numeric keypad. This could have benefits for the visually impaired or when operating in poor light. Clearly, number codes or large numbers may be input by placing the appropriate fingers onto the fingerprint reader in sequence.

A possible application of the invention is in controlling the operation of a piece of electronic equipment like a television. For example, if each television channel is allocated to one of a user's fingers, the television channel to be viewed may be selected by placing the appropriate of an individual's fingers onto a fingerprint reader. For example, channel one may be selected using one finger, channel two being selected using another finger. Where there are a large number of channels, then these may be selected by using appropriate fingers in sequence. As both the individual and the finger being used are identified, the television may be programmed to restrict access to some channels to a restricted group of authorised viewers, or alternatively some other settings of the television may be set to those preferred by that individual. Both the identity of the user and the channel chosen can be captured for audit and control purposes.

According to another aspect of the invention, the system may require two or more fingerprints to be input in sequence, the system determining whether the fingerprints have been input in a correct sequence and controlling operation of the device accordingly. In such an arrangement access rights are only granted when the fingerprints have been input in the correct sequence, thereby introducing an additional level of security as the sequence can be kept private to the individual and the sequence can be stored separately from the biometric template database. Although one fingerprint sequence is described, the invention is not limited to one sequence per individual and an individual can have two or more biometric sequences to enable the range of choice available to the individual for controlling a device or system to be extended.

According to another aspect of the invention, the system may require two or more fingerprints to be input simultaneously, the system determining whether the correct fingerprints have been input and the correct finger combination entry has been made and controlling operation of the device accordingly. In such an arrangement access rights are only granted when the correct finger combination entry has been input together, thereby introducing an additional level of security as the fingers used can be kept private to the individual and the finger combination entry can be kept separate from the biometric template database.

According to another aspect of the invention, the system may require two or more fingerprints to be input with different timing pauses between the finger entries, the system determining whether the correct fingerprints and correct timing pauses have been input between finger entries and controls the operation of the device accordingly. In such an arrangement access rights are only granted when the correct fingerprints and correct timing pauses between fingerprints have been input, thereby introducing an additional level of security as the finger timing pauses used can be kept private to the individual and stored separately from the biometric template database.

The finger sequence, finger combination entry and finger timing pauses can be used on their own, or combined together to provide an enhanced security capability. Although fingerprints are described above, the spirit of the invention includes any other biometric characteristics which can be used for identification purposes.

It will be appreciated that in all of the arrangements mentioned hereinbefore, as the system must identify which of an operator's fingers or other biometric characteristics are being used to operate the device, and as fingerprints or other biometric characteristics provide an accurate technique for identifying individuals, the system automatically identifies the individual operating the device.

Where multiple fingers or biometric characteristics are used in a sequence, the system can relax the False Acceptance Rate and False Rejection Rate tolerances by using the first entry to create a candidate list of individuals, then using the second entry to identify the individual from the candidate list and then using the third entry to confirm identity. This is of benefit in large scale deployment of biometric security systems where millions if not billions of individuals may be involved.

The invention also relates to an identification method comprising entering first and second pieces of biometric information, comparing data representative of the first piece of biometric information with stored data held in a first data store, comparing data representative of the second piece of biometric information with stored data held in a second data store, and operating a device using the results of the two comparisons. Although two pieces of biometric information and two data stores are described above, more than two pieces of data and more than two data stores can be used to provide additional security of the system. An example of this multiple data store requirement is where portable data stores, like a smart card, contain multiple chips and each chip can act as a separate data store. Another example is with Grid computing where multiple computers are used together and each computer can provide its own data store.

The invention will further be described, by way of example, with reference to the accompanying drawings, in which:

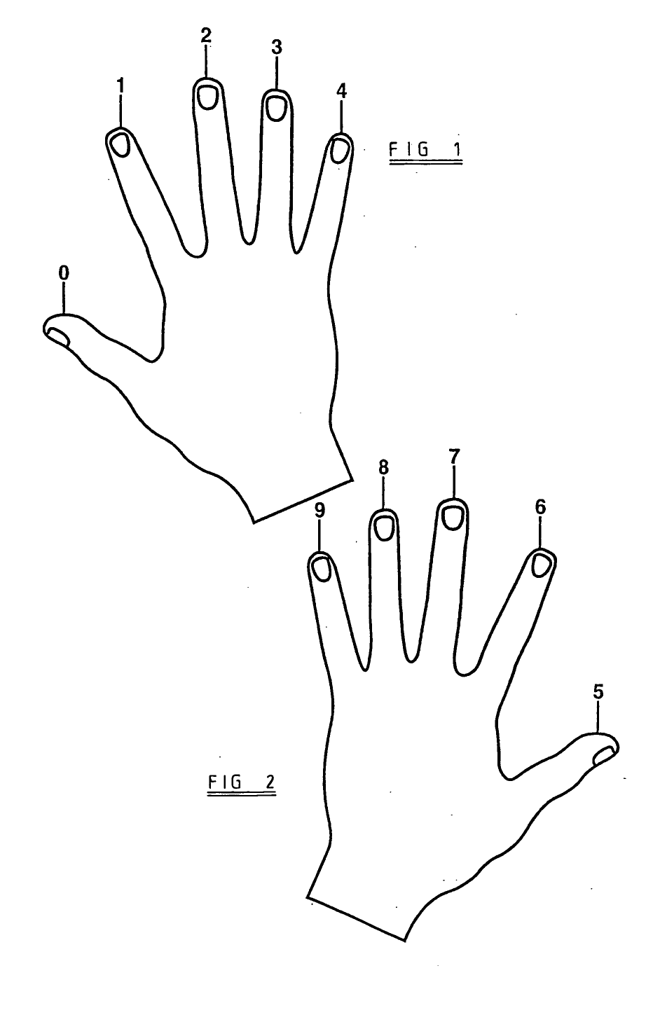

FIGS. 1 and 2 are views indicating possible codes associated with the fingers of a user's hands;

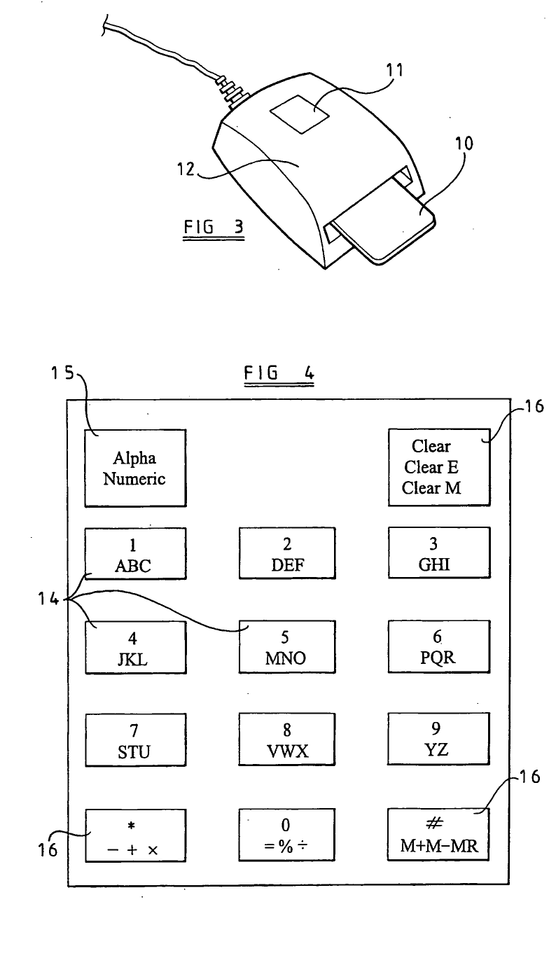

FIG. 3 is a view of a fingerprint reader suitable for use with the invention; and

FIG. 4 is a view of a keypad suitable for use with the invention.

As described hereinbefore, the invention is suitable for use in a wide range of applications. One possible application is in the inputting of numeric codes or numeric information or data. As illustrated in FIGS. 1 and 2, an individual's fingers have been allocated the digits 0 to 9. Data representative of the fingerprint patterns of all of the individual's fingers have been stored upon a smart card 10 (as illustrated in FIG. 3), or within a computer memory using a suitable fingerprint pattern reader and an appropriate recording device. The relationship between the stored fingerprint patterns and the allocation of the digits is also stored.

In use, when the individual wishes to input a numeric code or number, he simply places the appropriate ones of his fingers, in sequence, onto the sensor 11 of a fingerprint reader 12. In FIG. 3, the fingerprint reader 12 comprises a Biometrics Research Precise 100sc ID, but it will be appreciated that other readers could be used. The reader 12 is used, in conjunction with the stored fingerprint pattern data, to identify the individual and to identify which of his fingers have been placed upon the sensor 11. Provided the reader or a device connected to the reader 12 is programmed in such a manner as to associate the correct digit with each finger, then the information input through the reader 12 can be used to denote a numeric code. It will be appreciated that the fingerprint recognition technique used may be one of a number of publicly available, known recognition techniques.

By way of example, where the code 284 is to be entered, then the fingerprints of right hand finger 2, left hand finger 4 and then right hand finger 4 should be placed upon the sensor 11 of the reader 12 in sequence. Although a specific code or number is mentioned herein, it will be appreciated that any number can be input or entered using this technique.

Where the entered code or number constitutes a security access code for controlling access to, for example, data held on computer as both the identity of the individual and the sequence in which the digits of the code or number are entered are recognised by the identification system, the system provides an identification system having an improved level of security over both systems that simply require the input of an identification number and over systems that use a single fingerprint to identify an individual. Although in the description hereinbefore a numeric code is input, it will be appreciated that this need not be the case, and that all that is required is that the fingerprints are input in the correct sequence. However, the allocation of numeric digits to the fingers may be advantageous particularly where the device requires the input of numeric information, in that subsequent operation of the device may be achieved without providing a numeric keypad. The invention may, therefore, be suitable for use in, for example, an automatic bank teller machine or Point of Sale terminal or kiosk. The avoidance of the provision of a numeric key pad may be advantageous in that the cost of the device can be reduced, the risk of damage may be reduced and operation of the device in areas of poor lighting or by the visually impaired may be simplified as individual keys do not need to be depressed but rather a fingerprint input on a reader which may be of relative large dimensions.

The advantages mentioned above with regard to the avoidance of the provision of a keypad, use in areas of poor lighting or where the device is to be used by the visually impaired may be applicable in a wide range of other devices.

Although in the description hereinbefore, a number of fingerprints are input in a predetermined sequence in order to gain control of a device, this need not be the case. Instead, control of a device may be achieved by inputting a single fingerprint or by inputting several fingerprints simultaneously or by using timing pauses in a fingerprint sequence. The device being controlled in accordance with which of the individuals fingerprints or timing pauses are input.

In the arrangements described hereinbefore the stored fingerprint pattern data is held in a single location. Obviously there is the risk that if an unauthorised user gained access to the stored data he would be able to by-pass the enhanced security achieved using the invention. Rather than have the data stored in a single location, security may be further enhanced by dividing the data between two or more locations.

The following example relates to the method of the invention where data is stored in two locations and is used in controlling the operation of a financial terminal like an automated teller machine (ATM) or Point of Sale terminal or similar machine by an individual to determine whether or not the individual is authorised to access bank account information or process transactions, for example the withdrawal of money from the ATM.

In accordance with the method of the invention, a user of an ATM is issued with a smart card, that is to say a computer readable card carrying information relating to the individual's bank account, for example encoded information setting out the account number for the account. In addition, the card carries a storage device in the form of a chip capable of storing a relatively large amount of data. The storage device is programmed with user account data including biometric information representative of a characteristic of the individual, for example with fingerprint information relating to the fingerprint of the first finger of the individual's right hand.

A second piece of biometric information is stored upon, for example, a central computer database to which the ATM is connected. By way of example, the central computer database may be programmed with data representative of the fingerprint pattern of the user's second finger of his right hand.

In use, prior to being able to use the ATM to withdraw cash or perform another transaction, the user inserts his card into a card reader associated with the ATM. He then places, in sequence, the first and second fingers of his right hand on to a fingerprint pattern reader or scanner associated with the ATM. Fingerprint data representative of the two input fingerprints patterns are then compared with the stored fingerprint information held on the smart card and on the central computer database. A number of techniques are known for use in the automated comparison of input fingerprint pattern information with stored fingerprint data. Any of these techniques may be used, and so no description of how the comparison operation is performed is given here. The results of the two comparison operations can be used to determine firstly whether or not the user is the authorised user of the card, and also whether the user is authorised to perform transactions on the account to which the card relates.

The identification technique described hereinbefore has a number of advantages. Firstly, as it is comparing input data with stored data held in different locations the system is of improved security. There is also the advantage that only some of an individual's fingerprint information is permanently stored on the banks central database, rather than a full set of fingerprint information, thus the system may be viewed more favourably with those concerned about an individual's privacy than may otherwise by the case.

Other benefits of the system are that it could be used to enable a user to signal that he is being forced to operate the system under duress. By way of example, if a user places an incorrect finger on to the fingerprint reader, the result of the comparison operation may correctly identify the user, but the failure of the user to use his correct finger may be taken as an indication that he is being forced to use the system under duress. By way of example, the operator may place his finger, the fingerprint data of which is stored on the smart card on to the fingerprint reader at a time when he should have placed one of his fingers, the fingerprint data is held on the computer system, on to the fingerprint reader. Under such circumstances, the system may operate an alarm, and give the user limited use or no use of the system.

Although reference is made to using two separate data stores, it will be appreciated that the technique of the invention may be further extended to use more than two data stores.

A further benefit of the system is that it may be easier to use by those who may struggle to use a conventional keypad, for example the visually impaired or those simply unused to using a keypad, as the system is less reliant upon the use of a keypad. As well as being easier to use, the security benefits outlined above will apply by virtue of the data being held in different locations.

There are a number of ways in which the simple method described hereinbefore may be enhanced. By way of example, if an increased number of fingerprints or other biometric characteristics are stored in either location, additional checks may be performed. The additional checks could include requiring the fingerprints to be read in a pre-determined order or sequence or finger combination entry or timing pauses between finger entry all of which are known to the user, as described hereinbefore, but bearing in mind that some of the fingerprint information is stored in the first store and some is stored in the second store. Alternatively, the ATM could be programmed in such a manner as to request the user to place one or more of his fingers on to the reader, the selection of which finger(s) to use being determined, for example, by a random number generator built into the program.

Another possibility is that the first and second pieces of biometric information may be parts of a single biometric characteristic. By way of example, an input fingerprint or iris pattern may be divided into two or more parts, one of which is compared with data representative of part of a biometric characteristic held on, for example, a smart card or biometric document or electronic file and another part of the input biometric being compared with data representative of part of a biometric characteristic stored, for example, on a computer system. It will be appreciated that, using this technique, no single data store contains data representative of even one complete biometric characteristic and no complete biometric characteristic is transmitted between the biometric reader and the data stores.

In the description hereinbefore reference is made to the entry of fingerprint or other biometric information in a sequence, the input sequence entered being used in controlling the operation of the device, controlling access rights or in the input of data. Where data is stored in two or more locations, one additional possibility is to compare a first input data sequence with data held in a first data store and to compare a second input sequence with data stored in a second data store. Such a technique may allow a further enhancement in achievable system security.

If the techniques described hereinbefore are used, then it will be appreciated that the comparison operation may sometimes require modification to allow for, for example, fingerprints being entered at different angles or with different pressure or with different time pauses between presenting each finger in a sequence to the reader. In this way additional randomness is built into the security system which makes it more difficult for an unauthorised user to know how to present a duplicated fingerprint to the reader. Only the authorised user will know the sequence, angle of use, pressure or time interval between use of the fingers in the sequence. The system will be programmed to identify an appropriate position at which to divide the input biometric characteristic into the two or more parts.

As described hereinbefore, by allocating a number or digit to each of a user's fingers, multi-digit numbers can be input without using a conventional keypad. Although the digits can be allocated to each of a user's fingers in sequence as described hereinbefore, this need not be the case. As a result, multi-digit numbers can be input with increased privacy and security as a passer-by would not be able to ascertain the input number without knowing the relationship between the user's fingers or with the angle of use, pressure or timing intervals between use of the fingers. Further, by storing fingerprint data in two locations, neither containing a full set of the data, an unauthorised user would not be able to input the full range of numbers even if he had previously accessed one of the data stores to modify the data stored therein and ascertain the above-mentioned relationship.

Although the description hereinbefore relates primarily to the operation of an ATM using fingerprint information to determine whether or not a user is the authorised user, the invention may be used in a wide range of other financial terminals and applications and equipment, and other biometric characteristics may be used instead of or in conjunction with fingerprint information. Further, although two specific examples of locations in which fingerprint data can be stored are given, the data may be stored in other locations.

One alternative application of the invention is in systems requiring input from two or more users, for example systems in which an operator enters information or requests a task to be undertaken, the operator's entry or request subsequently being authorised or validated before being entered or completed. In such applications, the operator may have one biometric characteristic read and compared with a data stored in one location, for example on a primary database, smart card, electronic data file, or a biometric document. He then enters information for verification by a second user, and this information is sent together with data representative of a second biometric characteristic to the second user. The second user likewise enters one biometric characteristic, which is compared, for example, with data stored on a second database, electronic data file or smart card. Provided this comparison is accepted, he can then validate the request by entering a second fingerprint or other biometric characteristic, which is sent with the original request and the already attached biometric data to be processed. Prior to being approved, both of the attached biometric data are compared with centrally held data. This technique allows an electronic “signature” to be attached to a request in a secure manner, and may be suitable for use by, for example, e-commerce transactions, Point of Sales terminals, financial institutions or, with appropriate modification, for controlling access to buildings, secure sites like border crossings and airports and to a wide area network or computer system allowing remote access thereto. Although this example uses two users—the requester and the validator; the spirit of the invention does not limit this to two users and more than one user of a group of users could be involved in creating and requesting approval and more than one user likewise involved in approving the request.

1. A secure control system for use in controlling the operation of a device having a plurality of functions, the secure control system comprising inputting biometric data relating to a biometric characteristic of an individual, comparing the biometric data with stored biometric data to identify and audit the individual whose biometric data has been input and to identify to which of the individual's biometric characteristics the biometric data relates and referencing the identified biometric characteristic to a function, and controlling and auditing the operation of the device in response to the data representative of the identity both of the individual and of the biometric characteristic to perform a selected one of the plurality of functions.

2. A system as claimed in claim 1, wherein the device comprises a computer system and the data representative of the identity of the individual and of the biometric characteristic are used in controlling access rights to the computer and to applications and functions on the computer.

3. A system as claimed in claim 1, wherein the device comprises an electronic transaction and the data representative of the identity of the individual and of the biometric characteristic are used in controlling how the transaction is to be accessed and processed.

4. A system as claimed in claim 1, wherein the device comprises a data file and the data representative of the identity of the individual and of the biometric characteristic are used in controlling how the data file is to be accessed and updated.

5. A system as claimed in claim 1, wherein the device comprises a switch mechanism and the data representative of the identity of the individual and the biometric characteristic are used to control access to the switch mechanism and determine how the switch mechanism operates and/or what is controlled by the switch mechanism.

6. A secure control system for use in controlling the operation of a device having a plurality of functions, the secure control system comprises inputting biometric data relating to two or more biometric characteristics, comparing the input biometric data with stored biometric data to identify and audit the individual whose biometric data has been input and to identify to which of the individual's biometric characteristics the biometric data relates and referencing the sequence of entry of the identified biometric characteristics to a function, and controlling and auditing the operation of the device in response to the data representative of the identity both of the individual and of the referenced sequence to perform a selected one of the plurality of functions.

7. A system as claimed in claim 6, wherein the device comprises a computer system and the data representative of the identity of the individual and of the referenced sequence are used in controlling access rights to the computer and to applications and functions on the computer.

8. A system as claimed in claim 6, wherein the device comprises an electronic transaction and the data representative of the identity of the individual and of the referenced sequence are used in controlling access to the transaction and how the transaction is to be processed.

9. A system as claimed in claim 6, wherein the device comprises a data file and the data representative of the identity of the individual and of the referenced sequence entered are used in controlling how the data file is to be accessed and updated.

10. A system as claimed in claim 6, wherein the device comprises a switch mechanism and the data representative of the identity of the individual and the referenced sequence entered are used to control access to the switch mechanism and determine how the switch mechanism operates and/or what is controlled by the switch mechanism.

11. A secure control system for use in controlling the operation of a device having a plurality of functions, the secure control system comprising inputting biometric data relating to two or more biometric characteristics simultaneously, comparing the input biometric data with stored biometric data to identify and audit the individual whose biometric data has been input and to identify to which of the individual's biometric characteristics the input biometric data relates and referencing the combination of the identified biometric characteristics to a function, and controlling and auditing the operation of the device in response to the data representative of the identity both of the individual and of the combination of biometric characteristics entered to perform a selected one of the plurality of functions.

12. A system as claimed in claim 11, wherein the device comprises a computer system and the data representative of the identity of the individual and of the combination entered are used in controlling access rights to the computer and to applications and functions on the computer.

13. A system as claimed in claim 11, wherein the device comprises an electronic transaction and the data representative of the identity of the individual and of the combination entered are used in controlling access to the transaction and how the transaction is to be processed.

14. A system as claimed in claim 11, wherein the device comprises a data file and the data representative of the identity of the individual and of the combination entered are used in controlling how the data file is to be accessed and updated.

15. A system as claimed in claim 11, wherein the device comprises a switch mechanism and the data representative of the identity of the individual and the combination entered are used to control access to the switch mechanism and determine how the switch mechanism operates and/or what is controlled by the switch mechanism.

16. A secure control system for use in controlling the operation of a device having a plurality of functions, the secure control system comprising inputting biometric data relating to two or more biometric characteristics with timing pauses between each entry, comparing the input biometric data with stored biometric data to identify and audit the individual whose biometric data has been input and to identify to which of the individual's biometric characteristics the biometric data relates and referencing the timing pauses between entry of the biometric data to a function, and controlling and auditing the operation of the device in response to the data representative of the identity both of the individual and of the referenced timing pauses to perform a selected one of the plurality of functions.

17. A system as claimed in claim 16, wherein the device comprises a computer system and the data representative of the identity of the individual and of the referenced timing pauses are used in controlling access rights to the computer and to applications and functions on the computer.

18. A system as claimed in claim 16, wherein the device comprises an electronic transaction and the data representative of the identity of the individual and of the referenced timing pauses are used in controlling access to the transaction and how the transaction is to be processed.

19. A system as claimed in claim 16, wherein the device comprises a data file and the data representative of the identity of the individual and of the referenced timing pauses are used in controlling how the data file is to be accessed and updated.

20. A system as claimed in claim 16, wherein the device comprises a switch mechanism and the data representative of the identity of the individual and the referenced timing pauses are used to control access to the switch mechanism and determine how the switch mechanism operates and/or what is controlled by the switch mechanism.

21. A secure control system for use in controlling the operation of a device having a plurality of functions, the secure control system comprising inputting biometric data relating to two or more biometric characteristics and/or a sequence and/or combination entry and/or with timing pauses between each entry, comparing the input biometric data with stored biometric data to identify and audit the individual whose biometric data has been input and to identify to which of the individual's biometric characteristics the input biometric data relates and referencing the sequence and/or the combination entry and/or the timing entry of the identified biometric characteristics to a function, and controlling and auditing the operation of the device in response to the data representative of the identity both of the individual and of the sequence and/or combination entry and/or timing entry to perform a selected one of the plurality of functions.

22. A system as claimed in claim 21, wherein the device comprises a computer system and the data representative of the identity of the individual and of the sequence and/or the combination entry and/or the timing entry are used in controlling access rights to the computer and to applications and functions on the computer.

23. A system as claimed in claim 21, wherein the device comprises an electronic transaction and the data representative of the identity of the individual and of the sequence and/or the combination entry and/or the timing entry are used in controlling access to the transaction and how the transaction is to be processed.

24. A system as claimed in claim 21, wherein the device comprises a data file and the data representative of the identity of the individual and of the sequence and/or the combination entry and/or the timing entry are used in controlling how the data file is to be accessed and updated.

25. A system as claimed in claim 21, wherein the device comprises a switch mechanism and the data representative of the identity of the individual and the sequence and/or the combination entry and/or the timing entry are used to control access to the switch mechanism and determine how the switch mechanism operates and/or what is controlled by the switch mechanism.

26. An identification method comprising entering first and second pieces of biometric information, comparing data representative of the first piece of biometric information with stored data held in a first data store, comparing data representative of the second piece of biometric information with stored data held in a second data store, and identifying the individual and operating a device using the results of the two comparisons.

27. A method according to claim 26, wherein one or both of the first and second data stores comprise a portable data store.

28. A method according to claim 26 or claim 27 wherein the first and second pieces of biometric information are entered simultaneously.

29. A method according to claim 28, wherein the first and second pieces of biometric information form parts of a single biometric characteristic.

30. A method according to claim 29, wherein the single biometric characteristic comprises one of a fingerprint pattern and the other of a different biometric characteristic.

31. A method according to claim 26, wherein the first and second pieces of biometric information are entered sequentially.

32. A system as claimed in claim 1 wherein data relating to a plurality of biometric characteristics is entered in sequence to identify the individual from the biometric data supplied and to select more than one function out of the plurality of functions, each biometric characteristic in the sequence being linked to one function out of the plurality of functions.

33. A system as claimed in claim 1 wherein biometric data relating to a sequence of biometric characteristics is input and used to identify the individual and to select one or more functions out of the plurality of functions, each biometric characteristic sequence being linked to one function out of a plurality of functions.

34. A system as claimed in claim 26 wherein the first and second pieces of data entered are both biometric sequences and the identity of the individual and the operation of a device is dependent on both the biometric matching of the individual with biometric data relating to the individual held on the two data stores and the matching of the biometric sequences held on the two data stores.

35. A system as claimed in claim 34 where the second biometric sequence is only entered after confirmation from the system that the first biometric sequence has been used to identify the individual, the second biometric sequence acting to verify the identity of the individual and permit the operation of the device.

36. A system as claimed in claim 1 where multiple biometric characteristics are used in a sequence to relax the False Acceptance Rate and False Rejection Rate tolerances existing in the system, by using a first biometric entry to create a candidate list of possible matched individuals, then using a second biometric entry to identify the individual on the candidate list and then using a third biometric entry to confirm the identity of the individual.

37. A system as claimed in claim 26 wherein more than two pieces of data are entered as biometric characteristics and the identity of the individual and the operation of a device is dependent on both the biometric matching of the individual with biometric data relating to the individual held on one or more of the data stores and the matching of the biometric characteristic held on one or more of the multiple data stores.

38. A system as claimed in claim 26 wherein more than two pieces of data are entered as biometric sequences and the identity of the individual and the operation of a device is dependent on both the biometric matching of the individual with biometric data relating to the individual held on one or more of the data stores and the matching of the biometric sequences held on one or more of the multiple data stores.

39. A secure data entry system comprising assigning a data character to each of a plurality of an individual's biometric characteristics, inputting biometric data relating to one of the biometric characteristics of the individual, and comparing the input biometric data with stored biometric data to identify the individual whose biometric data has been input and to identify to which of the individual's biometric characteristics the biometric data relates to determine which data character has been input.

40. A system as claimed in claim 39, wherein each data character comprises a numeric digit, and using the system to input a number.

41. A system as claimed in claim 39, wherein the step of comparing is repeated at least once using fresh biometric data to permit a multi-digit number or numeric sequence to be input.
